(19) United States
(12) Patent Application Publication
(10) Pub. No.: US 2022/0261018 A1
(43) Pub. Date: Aug. 18, 2022

(54) VENTED DIAPHRAGM REGULATOR

(71) Applicant: LIEBHERR-AEROSPACE TOULOUSE SAS, Toulouse (FR)

(72) Inventors: Jean-Luc MANCHO, Toulouse (FR); David LOSSOUARN, Toulouse (FR); Antoine PEYRE, Toulouse (FR)

(21) Appl. No.: 17/619,105

(22) PCT Filed: Jun. 12, 2020
(86) PCT No.: PCT/FR2020/051015

§ 371 Date: Dec. 14, 2021

(30) Foreign Application Priority Data
Jun. 14, 2019 (FR) FR1906415

(51) Int. Cl. G05D 16/18; B64D 13/00; F02C 7/18; F02C 6/04

(52) U.S. Cl. CPC G05D 16/185; B64D 13/006; F02C 7/18; F05D 2260/20; F05D 2270/303; F05D 2270/65; F02C 6/04

(57) ABSTRACT

The invention relates to a regulator, configured to receive a stream of hot air carrying pneumatic power via an air inlet (12), to treat this hot air and to send the treated hot air to an air outlet (14) configured 5 to supply a pneumatic actuator (16), comprising a reference pressure source and an air expansion device comprising a diaphragm (22), the diaphragm (22) being configured to control the flow rate of the hot air stream by comparing the pressure of said hot air stream with the reference pressure of the reference pressure source. The regulator is characterized in that it 10 comprises an air intake (24) configured to receive a cold source, and a pipe (25) for guiding the cold source to the diaphragm (22), so that the cold source forms the reference pressure source and a source for cooling the diaphragm (22).

### TECHNICAL FIELD OF THE INVENTION

The invention relates to a regulator. In particular, the invention relates to a regulator allowing the treatment of hot air carrying pneumatic power, for example to allow a pneumatic actuator to be triggered. Such a regulator can be used in an aircraft, in particular to regulate the air supplied to the pneumatic actuator of a valve of the aircraft, in particular a valve of the air conditioning system.

### TECHNOLOGICAL BACKGROUND

The regulator allows the treatment of hot air carrying pneumatic power by various treatment elements. Such a regulator can also be known under the term “servo-control.”

When the regulator is used in a harsh thermal environment such as an aircraft, it is subjected to strong thermal stresses that require special treatment. In particular, the regulators comprise elements that are particularly sensitive to temperature, such as solenoids allowing the stream of air leaving the regulator to be managed, pressure regulating diaphragms, etc. More generally, the term “temperature-sensitive elements” is understood to mean elements that can in particular be damaged in the presence of a high temperature, or that have reduced performance in the presence of a high temperature.

Current solutions to protect these sensitive elements are for example:
Moving sensitive elements to a protected area: this solution nevertheless requires the addition of sensitive channels for transporting hot air or information streams, which has a strong impact on cost, weight and reliability, and makes the installation more complex;
Addition of ventilation of the area, either global over the entire area or directed toward sensitive elements: this solution has limited effectiveness on sensitive elements because it is not specific enough to these elements.

In addition, this solution has a strong impact on specific fuel consumption.

The inventors have sought a solution to avoid moving the sensitive elements elsewhere and to improve the ventilation of the sensitive elements of the regulator.

### AIMS OF THE INVENTION

The invention thus aims to provide a regulator benefiting from improved cooling.

The invention aims in particular to provide a regulator allowing the regulation of a valve, thus making it possible to form a compact valve by being placed close to the valve and the other elements with which it interacts, without having to move the temperature-sensitive elements to protected areas.

The invention also aims to provide a regulator that is particularly suitable for use in an aircraft.

### DISCLOSURE OF THE INVENTION

To do this, the invention relates to a regulator, configured to receive a stream of hot air carrying pneumatic power via an air inlet, to treat this hot air and to send the treated hot air to an air outlet configured to supply a pneumatic actuator, comprising a reference pressure source and an air expansion device comprising a diaphragm, said diaphragm being configured to control the flow rate of the hot air stream by comparing the pressure of said hot air stream with the reference pressure of the reference pressure source, the regulator being characterized in that it comprises an air intake configured to receive a cold source, and a pipe for guiding the cold source to said diaphragm, so that the cold source forms the reference pressure source and a source for cooling said diaphragm.
A regulator according to the invention thus makes it possible to cool the diaphragm of the air expansion device via an external cold source also serving as a reference pressure source.

In the systems of the prior art, the reference pressure source is atmospheric pressure, obtained owing to the ambient air surrounding the regulator.

The cold source used in the invention is preferably at a pressure close to ambient pressure, which makes it possible to use the invention with existing elements without requiring any design modification. However, compared to the ambient air, the cold source has a much lower temperature and is in motion (therefore with a non-negligible part dynamic pressure), which allows ventilation improving the cooling of the diaphragm compared to static ambient air, which does not allow good ventilation of the diaphragm.

Cooling the diaphragm allows the regulator to be placed in a harsh thermal environment without the need to move the regulator elsewhere. It is thus possible to set up a so-called “compact” system where all the elements of the regulator are as close as possible both to the hot air stream carrying pneumatic power and to the pneumatic actuator to be supplied with treated hot air.

In addition, the invention allows more efficient cooling than simple ventilation directed toward the regulator, since the cold source forming the reference pressure source is guided directly onto the diaphragm inside the regulator. The impact on specific fuel consumption is decreased and the need for cold air is much lower (approximately divided by three).

Advantageously and according to the invention, the regulator comprises at least one temperature-sensitive mechanical and/or electronic element arranged upstream or downstream of the diaphragm and the pipes allowing the cold source to be guided

toward said at least one temperature-sensitive mechanical and/or electronic element, the cold source allowing the cooling of said at least one temperature-sensitive mechanical and/or electronic element upstream or downstream of the cooling of the diaphragm.
According to this variant of the invention, the cold source can also be used to cool one or more other temperature-sensitive elements. The cooling of the element(s) can be done upstream or downstream of the cooling of the diaphragm, depending on the cooling needs of each element (the cold source being reheated upon each heat exchange with one of the elements or the diaphragm).
Advantageously and according to the invention, each temperature-sensitive mechanical and/or electronic element is chosen from one of the elements of the following list:
a solenoid,
mechanical and/or electronic component of a torque motor,
mechanical and/or electronic element of a servo-valve.

The solenoid in particular allows the management of the stream of air leaving the regulator, by opening or closing a flap allowing the exit of the quantity of air necessary to activate the pneumatic actuator at the desired moment.

Advantageously and according to the invention, the cold source is taken from a turbomachine.

Advantageously and according to the invention, the cold source is fan air taken from the turbomachine.

According to this aspect of the invention, the fan air from the turbomachine forms a particularly advantageous cold source in an aircraft because it is among the coldest air sources, with a pressure close to the ambient pressure of the aircraft, which makes it possible not to cause major modifications to the regulator. In particular, the expansion device operates in the same way without the need to resize the parts. Only

[symbol]

The fan air is air set in motion by the turbomachine. When the turbomachine is a turbojet, the fan air used and the fan air forming the secondary stream set in motion by the fan of the turbojet.

The fan air is also dynamic when it leaves the turbomachine, which allows the diaphragm to be ventilated without requiring any particular device to set the fan air in motion.

Advantageously and according to another variant of the invention, the cold source is primary engine air taken from the turbomachine.

The primary engine air is the air passing through the turbomachine and is 15 advantageously taken before its combustion in the combustion chamber of the turbomachine.

According to other variants of the invention, the cold source comes from another air stream generated by the turbomachine, or from a mixture of air streams generated by the turbomachine.

The invention also relates to a valve comprising a pneumatic actuator, characterized in that it comprises a regulator according to the invention configured to supply said pneumatic actuator.

By equipping a valve with a regulator according to the invention, it is possible to form a compact valve in which all the elements of the valve are arranged close to one another, without the need to move some of the elements of the valve elsewhere, in particular the temperature-sensitive regulator elements.

The valve can for example be used in an air conditioning system of an aircraft. The invention also relates to an aircraft comprising at least one turbomachine, characterized in that it comprises a regulator according to the invention, and a channel making it possible to guide fan air from the turbomachine toward the diaphragm of the

regulator expansion device, the fan air of the turbomachine thus forming the cold source and the reference pressure source of the diaphragm.

The invention also relates to a regulator, a valve and an aircraft that are characterized in combination by all or some of the features mentioned above or below.

### LIST OF FIGURES

Further aims, features and advantages of the invention will become apparent upon reading the following description, which is provided solely by way of a non-limiting example, and which refers to the accompanying figures, in which:

FIG. 1 is a schematic view of a regulator according to a first embodiment of the invention.

FIG. 2 is a schematic view of a regulator according to a second embodiment of the invention.

FIG. 3 is a schematic view of an expansion device of a regulator according to an embodiment of the invention

FIG. 4 is a simplified schematic view of an air conditioning system according to a first embodiment of the invention.

FIG. 5 is a simplified schematic view of an air conditioning system according to a second embodiment of the invention.

### DETAILED DESCRIPTION OF AN EMBODIMENT OF THE INVENTION

For the sake of illustration and clarity, scales and proportions are not strictly adhered to in the figures.

Moreover, identical, similar or analogous elements are denoted using the same reference signs throughout the figures.

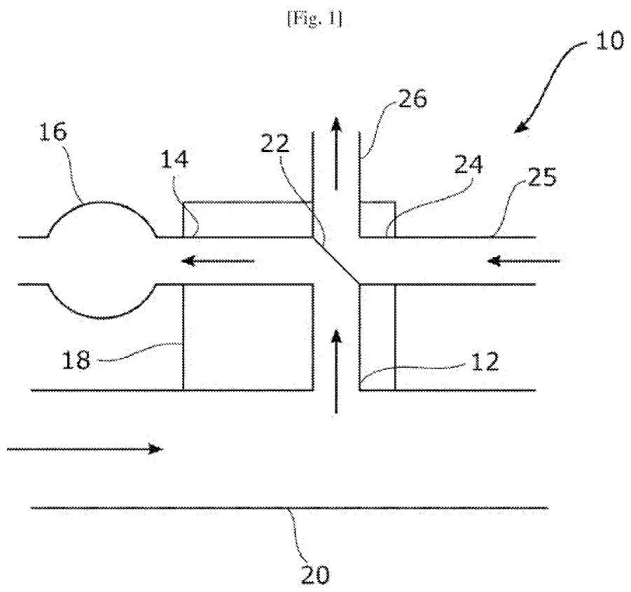

FIG. 1 illustrates a regulator 10 according to a first embodiment of the invention. The regulator 10 is configured to receive a stream of hot air carrying pneumatic power via an air inlet 12, to treat this hot air and to send the treated hot air to an air outlet 14 configured to supply a pneumatic actuator 16. The treatment is carried out inside a regulator body 18.

The hot air stream here comes from a pipe 20 in which hot air circulates.

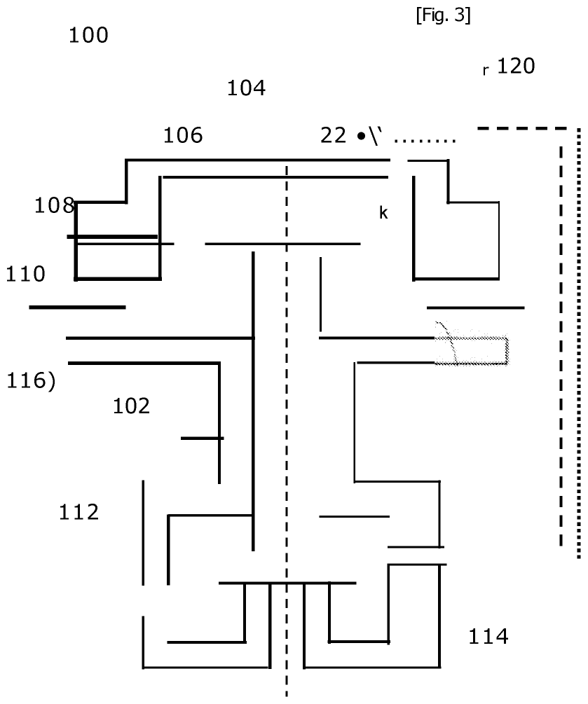

The hot air is then treated by an air expansion device, here shown schematically by its diaphragm 22, and described in more detail with reference to FIG. 3. The air expansion device, owing to its diaphragm 22, treats the stream of hot air entering through the air inlet 12. In particular, the diaphragm 22 is configured to control the flow rate of the hot air stream by comparing the pressure of the hot air stream with the pressure of a reference source, coming from an intake 24 of the reference source and led by a pipe 25. Once the reference source has passed through the diaphragm, it joins an air outlet 26, which can be connected to other systems or directly connected to the ambient air.

The diaphragm 22 is in contact with the hot air stream and thus undergoes strong thermal stresses that can damage it or alter its technical characteristics. The diaphragm 22 is therefore a temperature-sensitive mechanical element. In a prior art system, the reference pressure source is generally ambient air with ambient pressure. In an aircraft, the ambient air is generally hot due to the location of the regulator, and the ambient air has no dynamic component in its pressure.

In the invention, as shown schematically in this embodiment, the pressure source is at a temperature below the ambient air, and is a dynamic pressure source that allows the diaphragm to be effectively cooled and ventilated by directing the pressure source toward the diaphragm 22.

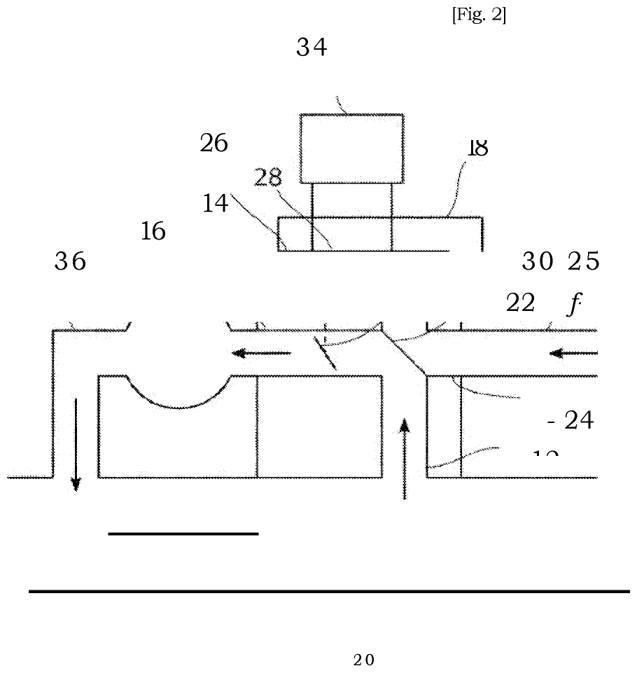

FIG. 2 schematically shows a regulator according to a second embodiment of the invention. The elements already described with reference to FIG. 1 bear the same reference and have the same functions.

This second embodiment allows the recovery of the air coming from the pressure source, after cooling of the diaphragm 22, in order to cool and ventilate one or more temperature-sensitive mechanical or electrical elements, for example here a solenoid 28, configured to open or close a flap 30 controlling the distribution of the air treated by the expansion device to supply the pneumatic actuator 16. The air cooling and ventilating the solenoid 28 can then supply other temperature-sensitive mechanical or electronic elements (not shown), then be discharged through the air outlet 26 toward the ambient air.

The solenoid 28 can thus be placed directly near the flap 30 that it controls, without the need to be moved elsewhere. It is controlled by a control device 34 that can be remote from it, for example forming part of the onboard computers of an aircraft.

In this embodiment, the air leaving the pneumatic actuator is guided by a pipe 36 toward the pipe 20 in which hot air circulates.

FIG. 3 schematically shows an air expansion device 100 according to an embodiment of the invention.

The air expansion device 100 comprises a piston 102 moving longitudinally along an axis 104 as a function of the respective pressures of a first chamber 106 and of a second chamber 108, separated by the diaphragm 22. The piston is constrained in position by a spring 110.

The air expansion device 100 compares the pressure of the hot air carrying pneumatic power present in the first chamber 106 with the pressure of the reference pressure source in the second chamber 108. The pressure difference allows the movement of the diaphragm, which, by moving, drives the piston, allowing the circulation of the hot air carrying pneumatic power present in the third chamber 112 toward an outlet 114 allowing the transmission of the air in the direction of the pneumatic actuator (in a regulator as described previously with reference to FIGS. 1 and 2).

The first chamber 106 and the third chamber 112, receiving hot air carrying pneumatic power, are connected by a connection 120.

The reference pressure source is in motion, entering through an air inlet 116 and exiting through an air outlet 118, thus allowing cooling and ventilation of the diaphragm as it passes. The air leaving through the air outlet 118 is either directly discharged to the ambient air, as in the first embodiment of the regulator described with reference to FIG. 1, or is used to cool and ventilate other temperature-sensitive elements, as in the second embodiment of the regulator described with reference to FIG. 2.

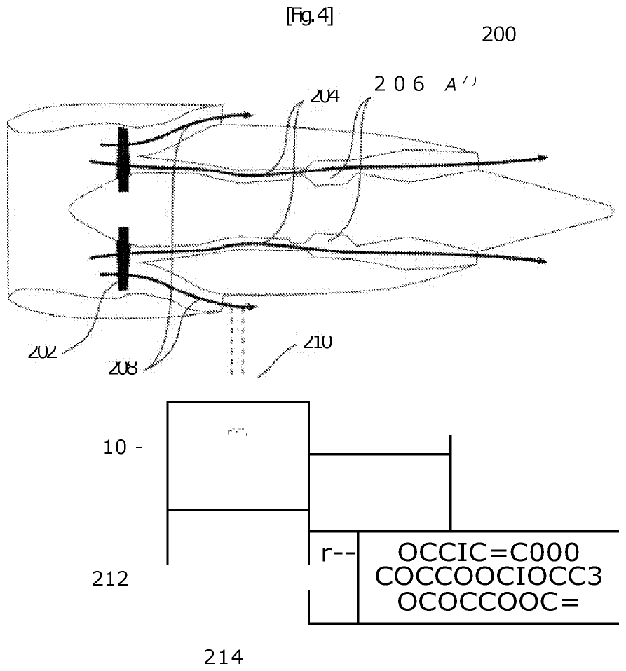

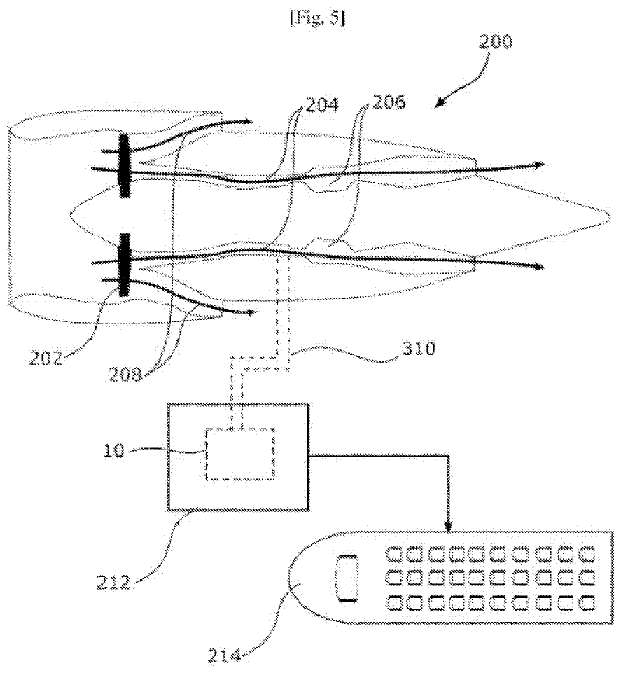

FIGS. 4 and 5 show, schematically and in a simplified manner, an air conditioning system according to an embodiment of the invention, installed in an aircraft and comprising a regulator according to one of the embodiments described above.

The aircraft comprises a turbomachine, in particular a turbojet 200, shown in a simplified manner, comprising a fan 202 allowing the formation of two air streams, a primary air stream 204 intended to be compressed and then injected into a combustion chamber 206, and a secondary air stream 208 circulating around the part of the turbojet 200 treating the primary air stream 204.

This secondary air stream, which is cold because it comes from the outside air entering the turbojet and having a dynamic pressure generated by the fan 202, forms fan air, so named because it is set in motion by the fan.

In the first embodiment shown in FIG. 4, this fan air is collected via a channel 210 leading to the regulator 10. The fan air thus collected serves as a reference pressure source for the regulator 10 and makes it possible to cool and ventilate the diaphragm, the solenoid and/or any electronic or mechanical elements sensitive to the desired temperature.

According to the second embodiment shown in FIG. 5, the reference pressure source forming a cold source is the primary air stream 204, which is collected via a channel 310 leading to the regulator. The primary air thus collected serves as a reference pressure source for the regulator 10 and makes it possible to cool and ventilate the diaphragm, the solenoid and/or any electronic or mechanical elements sensitive to the desired temperature.

According to other embodiments not described, the reference pressure source comes from another air stream of the aircraft, or from a mixture of several air streams of the aircraft, for example a mixture of fan air and primary air.

The regulator 10 is advantageously integrated into an air conditioning system 212 intended to condition the air in the cabin 214 of the aircraft, for example to control a pneumatic actuator making it possible to activate a valve of the air conditioning system 212.

The regulator can also be used in systems other than an air conditioning system, in particular any system that uses primary air such as relief valves, for example.

1. A regulator, configured to receive a stream of hot air carrying pneumatic power via an air inlet, to treat the hot air and to send the treated hot air to an air outlet configured to supply a pneumatic actuator, comprising:
a reference pressure source and an air expansion device comprising a diaphragm, said diaphragm being configured to control the flow rate of the hot air stream by comparing the pressure of said hot air stream with the reference pressure of the reference pressure source, wherein the regulator comprises an air intake configured to receive a cold source, and a pipe for guiding the cold source to said diaphragm, so that the cold source forms the reference pressure source and a source for cooling said diaphragm.

2. The regulator according to claim 1, further comprising at least one temperature-sensitive mechanical and/or electronic element arranged upstream or downstream of the diaphragm and pipes allowing the cold source to be guided toward said at least one temperature-sensitive mechanical and/or electronic element the cold source allowing the cooling of said at least one temperature-sensitive mechanical and/or electronic element upstream or downstream of the cooling of the diaphragm.

3. The regulator according to claim 2, wherein characterized in that each temperature-sensitive mechanical and/or electronic element is selected from the group consisting of:
a solenoid,
mechanical and/or electronic component of a torque motor,
mechanical and/or electronic component of a servo-valve.

4. The regulator according to one claim 1 wherein the cold source is taken from a turbomachine.

5. The regulator according to claim 4, wherein the cold source is fan air taken from the turbomachine.

6. The regulator according to claim 4, wherein the cold source is primary engine air taken from the turbomachine.

7. A valve actuated by a pneumatic actuator, comprising:
a-regulator configured to supply said pneumatic actuator, the regulator comprising a reference pressure source and an air expansion device comprising a diaphragm, said diaphragm being configured to control a flow rate of a hot air stream by comparing a pressure of said hot air stream with the reference pressure of the reference pressure source, wherein the regulator comprises an air intake configured to receive a cold source, and a pipe for guiding the cold source to said diaphragm, so that the cold source forms the reference pressure source and a source for cooling said diaphragm.

8. An aircraft comprising at least one turbomachine and comprising:
a regulator comprising a reference pressure source and an air expansion device comprising a diaphragm, said diaphragm being configured to control a flow rate of a hot air stream by comparing a pressure of said hot air stream with the reference pressure of the reference pressure source, wherein the regulator comprises an air intake configured to receive a cold source, and a pipe for guiding the cold source to said diaphragm, so that the cold source forms the reference pressure source and a source for cooling said diaphragm, and
at least one channel making it possible to guide fan air from the turbomachine toward the diaphragm of the regulator expansion device, the fan air of the turbomachine thus forming the cold source and the reference pressure source of the diaphragm.
